(19) United States
(12) Patent Application Publication
(10) Pub. No.: US 2007/0033041 A1
(43) Pub. Date: Feb. 8, 2007

(54) Method of identifying a person based upon voice analysis

(76) Inventor: Jeffrey W. Norton, Kenosha, WI (US)

Correspondence Address: Welsh & Katz, Ltd.;Jon P. Christensen, 22nd Floor, 120 South Riverside Plaza, Chicago, IL, 60606, US

(21) Appl. No.: 11/179,896

(22) Filed: Jul. 12, 2005

Related U.S. Application Data
(60) Provisional application No. 60/587,238, filed on Jul. 12, 2004.

(51) Int. Cl. G10L 15/04

(52) U.S. Cl. 704/254

(57) ABSTRACT

A method and apparatus are provided for identifying a person based upon a verbal statement of the person. The method includes the steps of sampling the verbal statement of the person and identifying a sequence of phonemes within the sampled statement. The method further includes the steps of measuring a time between each phoneme of the identified sequence of phonemes, comparing the identified sequence of phonemes with a corresponding reference sequence of phonemes of the person and confirming the identity of the person when the identified sequence of phonemes and reference sequence of phonemes match and the measured time among the identified sequence of phonemes substantially matches a corresponding time among the reference sequence of phonemes.

### FIELD OF THE INVENTION

The field of the invention relates to security systems and more particularly to methods of identification based upon voice.

### BACKGROUND OF THE INVENTION

Methods of voice identification based upon frequency analysis are known. Such methods are typically based upon a comparison of the frequency content of the speaker's voice with a template.

Typically, the process involves collecting a voice sample and performing a Fourier analysis of the speaker's voice to determine a frequency content of the spoken words. Because of the variability in frequency content of spoken words (even from the same speaker), the process may require a considerable time period to produce a reliable result. Word recognition may be used as an adjunct to the process as a means of identifying and comparing the frequency content of the same words.

While identification of a speaker based upon frequency content works relatively well, it is relatively slow and procedurally complex. In addition, the process is subject to a number of inherent process flaws. For example, if a speaker is nervous or under stress, the frequency content may vary considerably from the frequency content of the words of the speaker in a relaxed state. Similarly, if the speaker is intoxicated, either from prescription drugs or otherwise, the words may be slurred and difficult to match with a speech reference.

Because of the variability in the frequency content of spoken words, speaker identification is typically performed during conversational speech. However, recognizing conversational speech requires word recognition to identify and match the characteristics of reference words. Because of the importance of safety and security, a need exist for faster, more effective methods of verifying identify.

### BRIEF DESCRIPTION OF THE DRAWINGS

FIG. 1 depicts a system for identifying a person based upon a verbal statement of the person in accordance with an illustrated embodiment of the invention; and

FIG. 2 depicts the system of FIG. 1 used in the context of a telephone system.

### SUMMARY

A method and apparatus are provided for identifying a person based upon a verbal statement of the person. The method includes the steps of sampling the verbal statement of the person and identifying a sequence of phonemes within the sampled statement. The method further includes the steps of measuring a time between each phoneme of the identified sequence of phonemes, comparing the identified sequence of phonemes with a corresponding reference sequence of phonemes from the person and confirming the identity of the person when the identified sequence of phonemes and reference sequence of phonemes match and the measured time among the identified sequence of phonemes substantially matches a corresponding time among the reference sequence of phonemes.

### DETAILED DESCRIPTION OF AN ILLUSTRATED EMBODIMENT

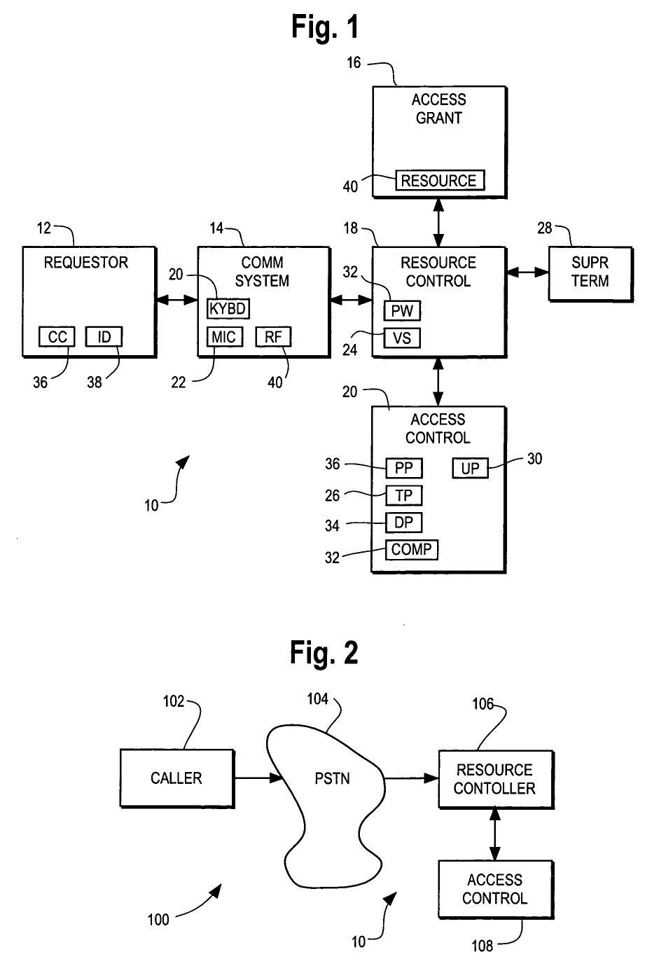

FIG. 1 depicts an identification system 10 shown generally in accordance with an illustrated embodiment of the invention. Under the illustrated embodiment, a human requestor 12 may request access to a resource through a resource controller 18. Access to the resource controller 18 may be provided through a communication system 14.

Under one illustrated embodiment, the resource being sought may be access to a secure area. Under this embodiment, the communication system 14 may be a speaker panel adjacent an access door. It may be assumed in this regard, that the system 10 has voice information from the requestor 12 that was previously stored in a memory of the system 10.

In order to initiate access, the requestor 12 may enter an identifier through a keyboard 20. In response, the system 10 may prompt the requester 12 to speak into a microphone 22. The system 10 may also prepare itself to accept the verbal statement, to process the verbal statement and to verify the identity of the requestor 12 based upon a content of the verbal statement.

In preparation for identification of the requester 12, the system 10 may ask the requester 12 to speak his name into the microphone 22. The system 10 may detect the spoken name and transfer the spoken name to a voice sampler (e.g., an analog to digital (A/D) converter) 24. The sampler 24 may sample the spoken name and transfer the samples to a phoneme processor for identification of the requester 12.

In general, it has been found that in the case of certain sequences of phonemes that together form word structures (e.g., names), the temporal relationship between phonemes is repeatable and unique to the speaker. For example, the recitation of the name “John Jones” is unique to each individual named John Jones. By recognizing the phonemes that make up each user's name and measuring the temporal spacing between each uttered phoneme of the name, a unique voice profile of each user can be captured and stored in each file.

In addition, the temporal relationship between phonemes may be relatively constant over the whole name, or only a portion of the name, or the temporal relationship may be based upon a proportionality factor. For example, some people have been found to pronounce their names with a relatively constant temporal spacing between the phonemes of their names. Other people may speak a first portion of their name (e.g., the last name) with a relatively constant spacing between the phonemes while another part of their name (e.g., the first name) may be spoken at a variable rate.

It has also been found then even when the temporal spacing between phonemes varies (e.g., the speaker sometimes recites his/her name at a rapid rate and sometimes at a slower rate), the proportionality factor remains the same. For example, if a reference profile of the user's name were normalized to a value of 1.00 and the user were to recite the user's name twice as fast, then the relationship between corresponding sequential temporal periods would be 50%. This does not mean that the spacing between each phoneme is equal, but only that the relationship of the temporal space between corresponding phonemes has the same relative proportionality over the portion of interest, no matter how rapidly the user recites his name.

Moreover, the temporal relationship between phonemes of the reference sequence of phonemes may be customized to the requestor 12 based upon their speech characteristics without loss of security. For example, a person who stutters or who has a speech impediment may still exhibit the same relative characteristics among phonemes between stuttering events. In this regard, an asymmetric equality may be present where the newly collected phoneme sequence has more phonemes (because of the stuttering) and the matched portion may be asymmetric or broken up with regard to the original reference phoneme sequence.

In this regard, some parts of a name of a requestor may be easier for that requester to recite than other parts of the name. In this case, recognition may be limited to that part of the name that is relatively repeatable. However, even when variability exists, recognition may still be achieved by having the requester 12 repeat the name until it has been determined that the repeated recitations fit the profile.

To allow access to a secure system, a voice profile of each user may be captured when that user first seeks access through the system. In the case of the system 10 of FIG. 1 and the described security system, a supervisor working through a supervisors station 28 may issue a temporary password for entry through the keyboard 20. The password may be stored within a temporary users file 32.

To access the space, the requester 12 may enter the password through the keyboard 20. In response, the resource controller 18 may compare the entered password with the stored passwords within the file 32 and if a match is found, grant access on a temporary basis. In addition, the resource controller 18 may also instruct the access control 20 to prepare to receive and process a new voice profile.

Following the grant of temporary access, the resource controller 18 may instruct the requestor 12 to recite a name into the microphone 22. The name recited into the microphone 22 may be transferred to the sampling processor 24 where the name may be sampled under an appropriate criteria and transferred to a phoneme processor 26 within the access controller 20.

Within the phoneme processor 26, a phoneme sequence may be detected from the samples using any appropriate detection routine. As each phoneme is detected, a time stamp may be attached to the phoneme. In addition, the time stamps of each detected phoneme may be transferred to a time processor 36 for a determination of the time interval between each phoneme of the phoneme sequence. The phonemes may be converted into a voice profile (i.e., a reference sequence) that includes the identified sequence of phonemes and the measured time between each phoneme in the sequence. The reference sequence may, in turn, be saved in a user profile file 30.

The resource controller 18 may then ask the requester 12 to repeat his name. In response, the phoneme processor 26 may repeat the process and compare the first voice profile with the second profile. If any significant differences are detected, then the process may be repeated a third time.

The first and second profiles may be transferred to a differences processor 34 to compare the profiles. Within the differences processor 34, the repeatable portion of the recited name may be identified and saved in the user file 30.

Thereafter, each time the requester 12 attempts gain access, the requester 12 may repeat his name into the microphone 22. The requestor 12 may also enter a password through the keyboard 20 or simply recite his name.

In response, the recited name may be sampled and transferred to the phoneme processor 26 where the newly generated phoneme sequence and time spacing may be compared with one or more user records 30 within a comparator 32 to detect a match. To identify the requestor 12, the comparison may be performed on a number of different levels.

On a first level, a match may be determined by a substantial match between the phoneme sequence and the timing among the phonemes. In this case, the comparator 32 may determine a time interval between each phoneme pair of the newly detected sequence. For example, the comparator 32 may determine the time period between the first and second phonemes in the newly received sequence, the time between the second and third phonemes in the new sequence, and so on. Once the timing between each phoneme pair is determined, the timing between corresponding phoneme sequences may be compared between the newly collected sequence and the reference sequence. If a match is found, then access is granted to the requester.

Failing to identify a match on a first level, the phoneme processor 26 may attempt to find a match based upon a proportionality factor in the case where the phoneme sequences match but the timing relationship between corresponding phoneme pairs does not match. In this case, the ratio of time periods between corresponding phoneme pairs may be determined and compared. If the ratios substantially match, then access is granted.

If a match is still not found, then the phoneme processor 26 may attempt to match the timing in subsets of the corresponding phoneme sequences. However matching of subsets may be limited by the variability detected in the initial training process where the reference sequence was obtained. In conjunction with the use of subsets, the requestor 12 may be asked to repeat his name to further improve upon the reliability of the match.

It should be noted that the use of names may not necessarily be limited to formal names. For example, nicknames could just as effectively be used for purposes of identification.

In addition, in other illustrated embodiments, the verbal statement may include a unique combinations of syllables (even nonsensical) for identification. For example, syllables that are not part of normal speech could provide the basis for identification. In this case, the reproducibility of results is believed to derive from the fact that the unique combination of syllables is recited by rote rather than to communicate.

In another illustrated embodiment, the reference sequence of phonemes and time intervals may be encoded into a remotely read identification card 38 carried by a user. For example, a radio frequency identification (RFID) chip may be embedded into the identification card. To gain access to a secure area, a radio frequency transceiver 40 may read the sequence of phonemes from the RFID chip within the identification card 38 at the time that the user request access to the secure area. Once the RFID information has been recovered, access may be gained as described above.

In another illustrated embodiment, such as that shown in FIG. 2, the system 10 may be incorporated into a telephone system 100. In this case, the requestor (i.e., caller 102) may dial a telephone number of resource controller 106. The resource controller 106 may accept the call and prompt the caller 102 to recite his unique set of identifying syllables. An access controller 108 may detect the identifying phonemes and grant access if a match is found, as described above.

The telephone system 100 may be used for any of a number of different telephone-related resources. For example, social workers may call into such a system 100 to deposit information about clients into an automatic data collection system.

In addition, the system 100 could be used as a method of more quickly and easily accessing personal bank accounts. The system 100 may be used by telephone subscribers to make telephone calls that could be charged to pre-existing accounts.

In addition, the system 10 of FIG. 1 could be used at point-of-sale (POS) terminals. Many stores offer such POS terminals in the purchase of consumer items. Such a system 10 offer security over other methods in that even if the person's unique combination of syllables were overheard, it is highly unlikely that an observer could reproduce the overheard syllables.

In the case of a POS terminal, the reference phonemes and time intervals may be encoded within a credit or debit card 36. The card 36 may be read at the POS terminal and the user may recite the identifying name into a microphone.

A specific embodiment of a system for identifying a person based upon a voice of the person has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of identifying a person based upon a verbal statement of the person, such method comprising the steps of:
sampling the verbal statement of the person;
identifying a sequence of phonemes within the sampled statement;
measuring a time between successive phonemes of the identified sequence of phonemes;
comparing the identified sequence of phonemes with a corresponding reference sequence of phonemes previously provided by the person; and
confirming the identity of the person when the identified sequence of phonemes and reference sequence of phonemes match and the measured time among the identified sequence of phonemes substantially matches a corresponding time among the reference sequence of phonemes.

2. The method of identifying the person as in claim 1 wherein the sequence of phonemes further comprises a name of the person.

3. The method of identifying the person as in claim 1 wherein the sequence of phonemes further comprises a nickname of the person.

4. The method of identifying the person as in claim 1 wherein the substantial match further comprises a proportional equality between corresponding sequential phonemes of the identified sequence and the reference sequence.

5. The method of identifying the person as in claim 4 wherein the proportional equality further comprises an asymmetric equality among corresponding portions of the identified sequence and the reference sequence.

6. The method of identifying the person as in claim 1 wherein the substantial match further comprises a temporal equality between corresponding sequential phonemes of the identified sequence and the reference sequence.

7. The method of identifying the person as in claim 1 further comprising retrieving the reference sequence from a credit card.

8. The method of identifying the person as in claim 1 further comprising retrieving the reference sequence from a radio frequency chip.

9. The method of identifying the person as in claim 1 further comprising receiving the sampled voice through a call connection established between a telephone and a call destination, retrieving the reference sequence from a memory of a call destination security system and granting telephone access privileges through the call destination based upon the substantial match.

10. An apparatus for identifying a person based upon a verbal statement of the person, such method comprising the steps of:
means for sampling the verbal statement of the person;
means for identifying a sequence of phonemes within the sampled statement;
means for measuring a time between successive phonemes of the identified sequence of phonemes;
means for comparing the identified sequence of phonemes with a corresponding reference sequence of phonemes from the person; and
means for confirming the identity of the person when the identified sequence of phonemes and reference sequence of phonemes match and the measured time among the identified sequence of phonemes substantially matches a corresponding time among the reference sequence of phonemes.

11. The apparatus for identifying the person as in claim 10 wherein the sequence of phonemes further comprises a name of the person.

12. The apparatus for identifying the person as in claim 10 wherein the sequence of phonemes further comprises a nickname of the person.

13. The apparatus for identifying the person as in claim 10 wherein the substantial match further comprises a proportional equality between corresponding sequential phonemes of the identified sequence and the reference sequence.

14. The apparatus for identifying the person as in claim 13 wherein the proportional equality further comprises an asymmetric equality among corresponding portions of the identified sequence and the reference sequence.

15. The apparatus for identifying the person as in claim 10 wherein the substantial match further comprises a temporal equality between corresponding sequential phonemes of the identified sequence and the reference sequence.

16. The apparatus for identifying the person as in claim 10 further comprising means for retrieving the reference sequence from a credit card.

17. The apparatus for identifying the person as in claim 10 further comprising means for retrieving the reference sequence from a radio frequency identification chip.

18. The apparatus for identifying the person as in claim 10 further comprising means for receiving the sampled voice through a call connection established between a telephone and a call destination, retrieving the reference sequence from a memory of a call destination security system and granting telephone access privileges through the call destination based upon the substantial match.

19. An apparatus for identifying a person based upon a verbal statement of the person, such method comprising the steps of:
an analog to digital converter that samples the verbal statement of the person;
a phoneme processor that identifies a sequence of phonemes within the sampled statement;
a time processor that determines a time between successive phonemes of the identified sequence of phonemes;
a comparator that compares the identified sequence of phonemes with a corresponding reference sequence of phonemes from the person; and
a reference phoneme sequence that confirms the identity of the person when the identified sequence of phonemes and reference sequence of phonemes match and the measured time among the identified sequence of phonemes substantially matches a corresponding time among the reference sequence of phonemes.

20. The apparatus for identifying the person as in claim 19 wherein the sequence of phonemes further comprises a name of the person.

21. The apparatus for identifying the person as in claim 19 wherein the sequence of phonemes further comprises a nickname of the person.

22. The apparatus for identifying the person as in claim 19 wherein the substantial match further comprises a proportional equality between corresponding sequential phonemes of the identified sequence and the reference sequence.

23. The apparatus for identifying the person as in claim 22 wherein the proportional equality further comprises an asymmetric equality among corresponding portions of the identified sequence and the reference sequence.

24. The apparatus for identifying the person as in claim 19 wherein the substantial match further comprises a temporal equality between corresponding sequential phonemes of the identified sequence and the reference sequence.

25. The apparatus for identifying the person as in claim 19 further comprising a credit card that provides the reference phoneme sequence.

26. The apparatus for identifying the person as in claim 19 further comprising a radio frequency identification chip that provides the reference phoneme chip.
